(19) United States
(12) Patent Application Publication
(10) Pub. No.: US 2020/0059401 A1
(43) Pub. Date: Feb. 20, 2020

(54) MANAGEMENT POD DEPLOYMENT WITH THE CLOUD PROVIDER POD (CPOD)

(71) Applicant: VMware, Inc., Palo Alto, CA (US)

(72) Inventors: Wade Holmes, Austin, TX (US); Simon Genzer, Brookline, MA (US); Aritra Paul, Palo Alto, CA (US); Yves Sandfort, Muenster (DE); Matthias Eisner, Vienna (AT); Fabian Lenz, Munich (DE); Philip Kriener, Drensteinfurt (DE); Joerg Lew, Rettenberg (DE); Chris Johnson, Austin, TX (US)

(73) Assignee: VMware, Inc., Palo Alto, CA (US)

(21) Appl. No.: 16/246,970

(22) Filed: Jan. 14, 2019

Related U.S. Application Data
(60) Provisional application No. 62/719,949, filed on Aug. 20, 2018.

(51) Int. Cl. H04L 12/24; G06F 9/455; H04L 29/08

(52) U.S. Cl. CPC H04L 41/0803; G06F 2009/45595; H04L 67/10; G06F 9/45558

(57) ABSTRACT

Automated deployment of a public cloud is disclosed. The technology accesses, via a user interface, a cloud provider pod designer including a plurality of cloud provider platform components. Instructions comprising a plurality of public cloud requirements are received via the user interface. In addition, optimization suggestions for a cloud provider platform and based on the public cloud requirements are provided via the user interface. The cloud provider pod designer then designs a cloud provider platform. The cloud provider platform is then deployed.

### CROSS-REFERENCE TO RELATED APPLICATIONS

This application claims benefit of U.S. Provisional Patent Application Ser. No. 62/719,949, filed Aug. 20, 2018, entitled “management pod deployment with the virtual cloud provider pod (VCPP) initiator virtual machine” by Wade Holmes et al., assigned to the assignee of the present application, having Attorney Docket No. E657.PRO, which is herein incorporated by reference in its entirety.

### GROUND

In conventional virtual computing environments, creating and managing hosts and virtual machines may be complex and cumbersome. Oftentimes, a user, such as an IT administrator, requires a high level and complex skill set to effectively configure a new host to join the virtual computing environment. Moreover, management of workloads and workload domains, including allocation of hosts and maintaining consistency within hosts of particular workload domains, is often made difficult due to the distributed nature of conventional virtual computing environments. Furthermore, applications executing within the virtual computing environment often require updating to ensure performance and functionality. Management of updates may also be difficult due to the distributed nature of conventional virtual computing environments.

### BRIEF DESCRIPTION OF DRAWINGS

The accompanying drawings, which are incorporated in and form a part of the Description of Embodiments, illustrate various embodiments of the subject matter and, together with the Description of Embodiments, serve to explain principles of the subject matter discussed below. Unless noted, the drawings herein should be understood as not being drawn to scale. Herein, like items are labeled with like item numbers.

FIG. 1 illustrates a block diagram of a computing system upon which embodiments of the present invention can be implemented.

FIG. 2 illustrates a block diagram of a cloud-based computing environment upon which embodiments described herein may be implemented.

FIG. 3 illustrates a block diagram of a CPOD environment, according to various embodiments.

FIG. 4 illustrates a flow diagram of a CPOD design and creation, according to various embodiments.

FIG. 5 illustrates a flow diagram of a method for automatically deploying the cloud provider pod design on a bare metal environment, according to various embodiments.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included in the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Some portions of the detailed descriptions which follow are presented in terms of procedures, logic blocks, processing and other symbolic representations of operations on data bits in a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “connecting,” “displaying,” “receiving,” “providing,” “determining,” “generating,” “establishing,” “managing,” “extending,” “creating,” “migrating,” “effectuating,” or the like, refer to the actions and processes of an electronic computing device or system such as: a host processor, a processor, a memory, a virtual storage area network (VSAN), a virtualization management server or a virtual machine (VM), among others, of a virtualization infrastructure or a computer system of a distributed computing system, or the like, or a combination thereof. It should be appreciated that the virtualization infrastructure may be on-premises (e.g., local) or off-premises (e.g., remote or cloud-based), or a combination thereof. The electronic device manipulates and transforms data represented as physical (electronic and/or magnetic) quantities in the electronic device's registers and memories into other data similarly represented as physical quantities in the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAIVI), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided in dedicated software modules or hardware modules configured as described herein. Also, the techniques could be fully implemented in one or more circuits or logic elements. A general-purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview

In general, there is the cloud provider pod (CPOD) designer which is the front facing web interface that a service provider will go to and put in the custom design criteria, based on business needs, so they want to be able to build a public cloud that provides a sets and migrate capability, add the DR capability, etc.

They will go to the front facing web interface, and select the criteria that is needed. Then CPOD based on that input will generate a customize documentation that shows architecture the design the operational guidance monetization guidance e.g., how they can monetize this service for their own customers and implementation guidance for any pieces that aren't fully automated that will be produced and output to the service provider.

The second piece that is created is a customized automation package that includes all the customized configuration details based on their inputs that is then going to be utilized in the second part of the CPOD product which is the on-premises CPOD deployer which is referred to as a CPOD initiator. CPOD deployer it is an installable virtual client that is downloaded from VMware installed on a primary system data center with the web interface in the cloud a web portal it is installed on their infrastructure and they take the automation package that was customized and is imported into the deployer and then through a single click they are able to kick off the automation field of the public cloud based on the criteria that was input into the designer.

What has not been done today is in regard to how the deployment is initially bootstrapped on to bare metal hardware. That is, how to deploy all software components and customize the components and the customized package that was created. The solution is to utilize VMware's hypervisor in a nested configuration, which means taking the hypervisor software installing it as an appliance underneath an existing Vsphere hypervisor and then under the nested Vsphere hypervisor. Having customized components that are the deployment engine that ingests the customized package and then kicks off the automated deployment to the physical hardware of the hardware stack.

This includes the customize document with different segments. Basically, the customized documentation that is received as the service provider/generator/developer would be based upon the input that I provide through the VCPC regarding the implementation details or requirements of my particular cloud once that is done based on what I selected I am going to get particular tailored and specified deployment documentation.

Thus, the present technology provides a solution to a problem that presently exists in designing, deploying, and updating a multi-tenant public cloud. In the design, deployment, and updating process each public cloud is made by a specific provider. Each provider may have different standards, coding, and the like. In some cases, the coding could allow for an expansion to the tenant's domain on the public cloud to include debugging or other limitations.

Importantly, the embodiments of the present invention, as will be described below, provide an approach for utilizing aVMware Cloud Provider Pod (CPOD) to modernize an existing cloud provider infrastructure with an automated design and deployment of the VMware cloud provider platform. In conventional approaches, since the tenant's environment is basically a customized design, the option of changing to a different provider would require the tenant to basically have an entire infrastructure re-designed and re-developed. Such activities are costly, complex and will cause significant down time while the new design is made operational.

Instead, the present embodiments, as will be described and explained below in detail, provide a previously unknown procedure for deploying and documenting a complete multi-tenant VMware validated design for service providers within minutes while providing guidance for all necessary cloud provider platform components such as VMware vSphere, VMware NSX, and VMware vCloud director, as well as optional products such as VMware vSAN, vCloud Extender, vRealize operations, vRealize log insight and vRealize network insight.

Embodiments described herein describe how a design is created, what is included in the design, and how a standardized VMware validated designs for service providers can be deployed. As will be described in detail, the various embodiments of the present invention do not merely implement conventional processes on a computer. Instead, the various embodiments of the present invention, in part, provide a previously unknown procedure for providing a build and deploy capabilities that enables out of the box utilization. Moreover, the design includes directions for providers, managers, and tenants and also a validation of the design for private and/or public clouds. Hence, embodiments of the present invention provide a novel process for designing, documenting and building a public and/or private tenant cloud in a multi-tenant environment which is necessarily rooted in computer technology to overcome a problem specifically arising in the realm of multi-tenant cloud environment design and deployment.

### Example Computing Environment

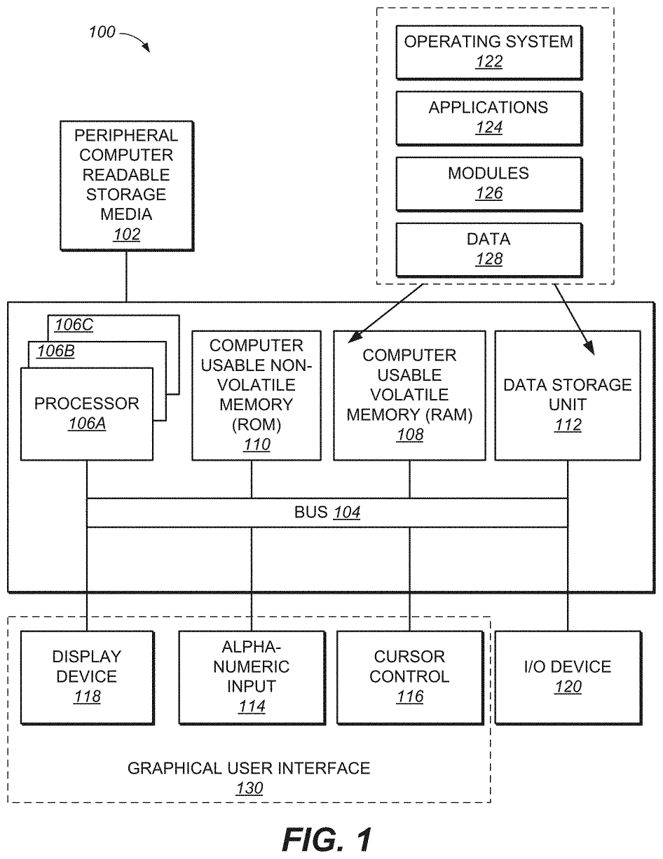

With reference now to FIG. 1, all or portions of some embodiments described herein are composed of computer-readable and computer-executable instructions that reside, for example, in computer-usable/computer-readable storage media of a computing system. That is, FIG. 1 illustrates one example of a type of computer (computing system 100) that can be used in accordance with or to implement various embodiments which are discussed herein.

It is appreciated that computing system 100 of FIG. 1 is only an example and that embodiments as described herein can operate on or in a number of different computing systems including, but not limited to, general purpose networked computing systems, embedded computing systems, routers, switches, server devices, client devices, various intermediate devices/nodes, stand-alone computing systems, media centers, handheld computing systems, multi-media devices, virtual machines, virtualization management servers, and the like. Computing system 100 of FIG. 1 is well adapted to having peripheral tangible computer-readable storage media 102 such as, for example, an electronic flash memory data storage device, a solid-state drive, a floppy disc, a compact disc, digital versatile disc, other disc-based storage, universal serial bus “thumb” drive, removable memory card, and the like coupled thereto. The tangible computer-readable storage media is non-transitory in nature.

System 100 of FIG. 1 includes an address/data bus 104 for communicating information, and a processor 106A coupled with bus 104 for processing information and instructions. As depicted in FIG. 1, system 100 is also well suited to a multi-processor environment in which a plurality of processors 106A, 106B, and 106C are present. Conversely, system 100 is also well suited to having a single processor such as, for example, processor 106A. Processors 106A, 106B, and 106C may be any of various types of microprocessors. System 100 also includes data storage features such as a computer usable volatile memory 108, e.g., random access memory (RAM), coupled with bus 104 for storing information and instructions for processors 106A, 106B, and 106C.

System 100 also includes computer usable non-volatile memory 110, e.g., read only memory (ROM), coupled with bus 104 for storing static information and instructions for processors 106A, 106B, and 106C. Also present in system 100 is a data storage unit 112 (e.g., a magnetic or optical disc and disc drive) coupled with bus 104 for storing information and instructions. System 100 also includes an alphanumeric input device 114 including alphanumeric and function keys coupled with bus 104 for communicating information and command selections to processor 106A or processors 106A, 106B, and 106C. System 100 also includes a cursor control device 116 coupled with bus 104 for communicating user input information and command selections to processor 106A or processors 106A, 106B, and 106C.

In one embodiment, system 100 also includes a display device 118 coupled with bus 104 for displaying information.

Referring still to FIG. 1, display device 118 of FIG. 1 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 116 allows the computer user to dynamically signal the movement of a visible symbol (cursor) on a display screen of display device 118 and indicate user selections of selectable items displayed on display device 118. Many implementations of cursor control device 116 are known in the art including a trackball, mouse, touch pad, touch screen, joystick or special keys on alphanumeric input device 114 capable of signaling movement of a given direction or manner of displacement.

Alternatively, it will be appreciated that a cursor can be directed and/or activated via input from alphanumeric input device 114 using special keys and key sequence commands. System 100 is also well suited to having a cursor directed by other means such as, for example, voice commands. In various embodiments, alphanumeric input device 114, cursor control device 116, and display device 118, or any combination thereof (e.g., user interface selection devices), may collectively operate to provide a UI 130 under the direction of a processor (e.g., processor 106A or processors 106A, 106B, and 106C). UI 130 allows user to interact with system 100 through graphical representations presented on display device 118 by interacting with alphanumeric input device 114 and/or cursor control device 116.

System 100 also includes an I/O device 120 for coupling system 100 with external entities. For example, in one embodiment, I/O device 120 is a modem for enabling wired or wireless communications between system 100 and an external network such as, but not limited to, the Internet.

Referring still to FIG. 1, various other components are depicted for system 100. Specifically, when present, an operating system 122, applications 124, modules 126, and data 128 are shown as typically residing in one or some combination of computer usable volatile memory 108 (e.g., RAM), computer usable non-volatile memory 110 (e.g., ROM), and data storage unit 112. In some embodiments, all or portions of various embodiments described herein are stored, for example, as an application 124 and/or module 126 in memory locations in RAM 108, computer-readable storage media in data storage unit 112, peripheral tangible computer-readable storage media 102, and/or other tangible computer-readable storage media.

The architecture shown in FIG. 1 can be partially or fully virtualized. For example, computing system 100 may be one or possibly many VMs executing on physical hardware and managed by a hypervisor, virtual machine monitor, or similar technology.

Furthermore, in some embodiments, some or all of the components of computing system 100 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like.

Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques.

### Example Computing Environment

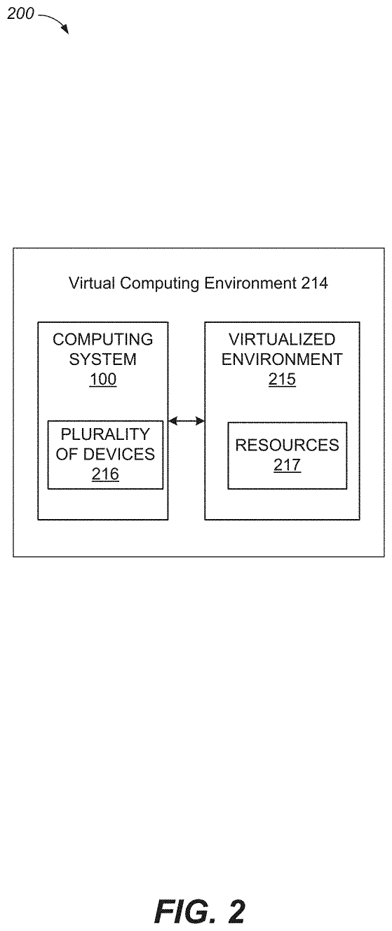

FIG. 2 illustrates an example virtual computing environment (VCE 214) upon which embodiments described herein may be implemented. In the cloud-computing paradigm, computing cycles and data-storage facilities are provided to organizations and individuals by cloud-computing providers. In addition, larger organizations may elect to establish private cloud network-computing facilities in addition to, or instead of subscribing to computing services provided by public cloud network-computing service providers.

In one embodiment, VCE 214 (or virtualization infrastructure) includes computing system 100 and virtualized environment 215, according to various embodiments. In general, computing system 100 and virtualized environment 215 are communicatively coupled over a network such that computing system 100 may access functionality of virtualized environment 215.

In one embodiment, computing system 100 may be a system (e.g., enterprise system) or network that includes a combination of computer hardware and software. The corporation or enterprise utilizes the combination of hardware and software to organize and run its operations. To do this, computing system 100 uses resources 217 because computing system 100 typically does not have dedicated resources that can be given to the virtualized environment 215. For example, an enterprise system (of the computing system 100) may provide various computing resources for various needs such as, but not limited to information technology (IT), security, email, etc.

In various embodiments, computing system 100 includes a plurality of devices 216. The devices are any number of physical and/or virtual machines. For example, in one embodiment, computing system 100 is a corporate computing environment that includes tens of thousands of physical and/or virtual machines. It is understood that a virtual machine is implemented in virtualized environment 215 that includes one or some combination of physical computing machines. Virtualized environment 215 provides resources 217, such as storage, memory, servers, CPUs, network switches, etc., that are the underlying hardware infrastructure for VCE 214.

The physical and/or virtual machines of the computing system 100 may include a variety of operating systems and applications (e.g., operating system, word processing, etc.). The physical and/or virtual machines may have the same installed applications or may have different installed applications or software. The installed software may be one or more software applications from one or more vendors.

Each virtual machine may include a guest operating system and a guest file system. Moreover, the virtual machines may be logically grouped. That is, a subset of virtual machines may be grouped together in a container (e.g., VMware apt). For example, three different virtual machines may be implemented for a particular workload. As such, the three different virtual machines are logically grouped together to facilitate in supporting the workload. The virtual machines in the logical group may execute instructions alone and/or in combination (e.g., distributed) with one another.

Also, the container of virtual machines and/or individual virtual machines may be controlled by a virtual management system. The virtualization infrastructure may also include a plurality of virtual datacenters. In general, a virtual datacenter is an abstract pool of resources (e.g., memory, CPU, storage). It is understood that a virtual data center is implemented on one or some combination of physical machines.

In various embodiments, computing system 100 may be a cloud environment, built upon a virtualized environment 215. Computing system 100 may be located in an Internet connected datacenter or a private cloud network computing center coupled with one or more public and/or private networks. Computing system 100, in one embodiment, typically couples with a virtual or physical entity in a computing environment through a network connection which may be a public network connection, private network connection, or some combination thereof.

As will be described in further detail herein, the virtual machines are hosted by a host computing system. A host includes virtualization software that is installed on top of the hardware platform and supports a virtual machine execution space within which one or more virtual machines may be concurrently instantiated and executed.

In some embodiments, the virtualization software may be a hypervisor (e.g., a VMware ESXTM hypervisor, a VMware Exit hypervisor, etc.) For example, if hypervisor is a VMware ESXTM hypervisor, then virtual functionality of the host is considered a VMware ESXTM server.

Additionally, a hypervisor or virtual machine monitor (VMM) is a piece of computer software, firmware or hardware that creates and runs virtual machines. A computer on which a hypervisor is running one or more virtual machines is defined as a host machine. Each virtual machine is called a guest machine. The hypervisor presents the guest operating systems with a virtual operating platform and manages the execution of the guest operating systems.

During use, the virtual machines perform various workloads. For example, the virtual machines perform the workloads based on executing various applications. The virtual machines can perform various workloads separately and/or in combination with one another.

### CPOD Operation

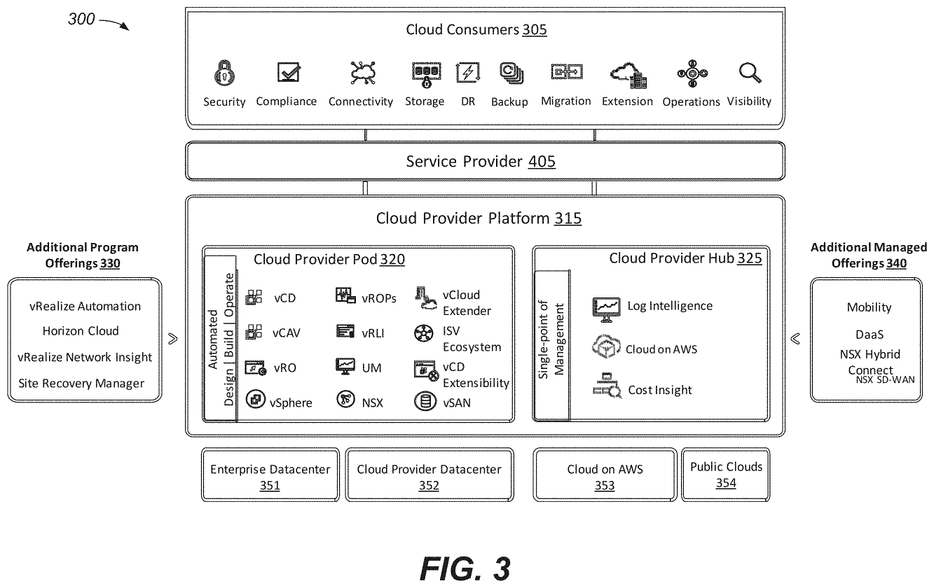

With reference now to FIG. 3, a block diagram of a CPOD environment 300 is shown in accordance with an embodiment. CPOD environment includes cloud consumers 305, service provider 405, cloud provider platform 315, CPOD 320, cloud provider hub 325, additional program offerings 330, additional managed offerings 340, enterprise datacenter 351, cloud provider datacenter 352, cloud on AWS 353, and public clouds 354.

Cloud consumers 305 are the customers/tenants that are requesting the environment. They can have a number of different requirements, needs, or the like that could be based on the tenant's desires, legal requirements, and the like. In general, the needs and requirements include features such as, but not limited to, security, compliance, connectivity, storage, disaster recovery (DR), backup, migration, extension, operations, visibility, and the like.

Service provider 405 is the middle entity between the technology provider (such as VMware) and the tenant. The service provider 405 works with the tenant on the design and features of the tenant's cloud environment. In one embodiment, the service provider 405 could have an environment that includes multiple tenants, e.g., a multi-tenant environment. In the case of multi-tenant environments, service provider 405 will need to ensure that the security will ensure that there is no seepage between the different tenants within the multi-tenant environment.

Cloud provider platform 315 includes CPOD 320 and cloud provider hub 325. CPOD 320 includes a number of building blocks such as, but not limited to, a vCloud Director (vCD)—which allows seamless provisioning and consumption of virtual resources in a cloud mode; vCloud availability (vCAV)-which allows service providers to offer simple, cost-effective cloud-based disaster recovery services that seamlessly support their customers' vSphere and virtual data center environments; vRealize Orchestrator (vRO)—which simplifies the automation of complex IT tasks with VMware vRealize Orchestrator, which integrates with vRealize Suite and vCloud Suite to further improve service delivery efficiency, operational management and IT agility; vSphere—a server virtualization platform; vRealize Operations (vROPs)—a software product that provides operations management across physical, virtual and cloud environments; vRealize log insight (vRLI)—which provides intelligent log management for infrastructure and applications; usage monitor (UM)—which reports on all VMs managed by the vCenter on which it's installed; NSX—a data center that is the network virtualization platform for the software—defined data center (SDDC), delivering networking and security entirely in software, abstracted from the underlying physical infrastructure; vCloud extender—which creates a hybrid cloud environment between an end-user on-premise data center, and a multi-tenant vCloud Director environment; ISV ecosystem—which supports independent software vendors (ISVs) applications running on VM on-premise and in the cloud; vCD extensibility—which is used to implement an effective and realistic cross-cloud deployment to solve inter-connectivity and compatibility issues when provisioning workloads into a multi-cloud environment; vSAN—a hyper-converged, software-defined storage (SDS) product that pools together direct-attached storage devices across a vSphere cluster to create a distributed, shared data store; and/or other building blocks that may be requested by a customer for use in the cloud environment.

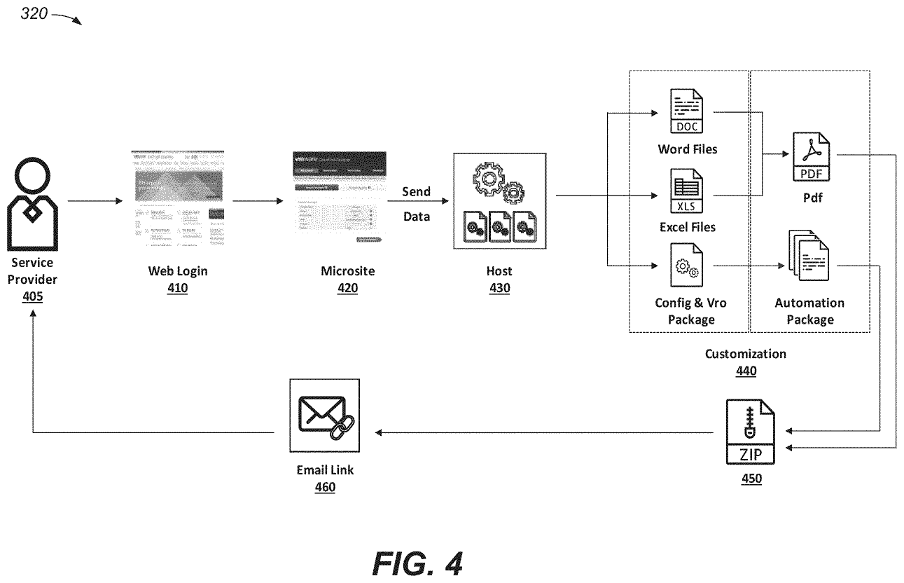

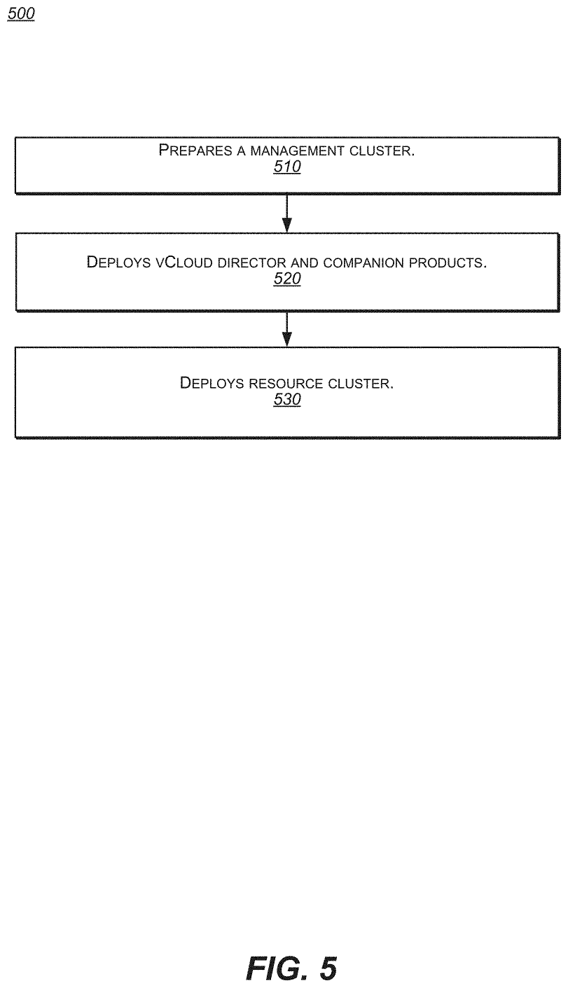

Although the building blocks are identified as VMware products it is done for purposes of clarity. It should be appreciated that there may be other products from other companies that perform similar tasks and could be easily incorporated/used in place of/or otherwise utilized by CPOD 320. CPOD 320 is described in operational detail in the discussion of FIGS. 4 and 5.

Cloud provider hub 325 is a single point of management that can include log intelligence which provides intelligent log management for cloud applications, ingests logs securely and efficiently, delivers sophisticated analytics, and handles a variety of machine-generated data and delivers near real-time monitoring; cloud on AWS—which delivers a highly scalable, secure service that allows organizations to seamlessly migrate and extend their on-premises vSphere-based environments to the AWS Cloud running on next-generation Amazon Elastic Compute Cloud (Amazon EC2) bare metal infrastructure; cost insights—which provides visibility into the cost of a private and public cloud infrastructure; and the like.

Additional program offerings 330 include a few (but not all) of the additional programs that could be utilized by CPOD 320. The additional program offerings 330 include vRealize automation—which accelerates the delivery of IT services through automation and pre-defined policies; horizon cloud—which enables the delivery of cloud-hosted virtual desktops and apps to any device, anywhere, from a single cloud control plane; vRealize network insight—which helps accelerate application security and networking across private, public and hybrid clouds; site recovery manager—a disaster recovery software to enable application availability and mobility across sites in private cloud environments with policy-based management, non-disruptive testing and automated orchestration; and the like.

Additional managed offerings 340 include a few (but not all) of the additional management tools that could be utilized by cloud provider hub 325. The managed offerings 340 include mobility—a capability to offer remote working options, allow the use of personal laptops and mobile devices for business purposes and make use of cloud technology for data access; DaaS—which delivers O/S desktops and hosted apps as a cloud service to any user anywhere, on any device; NSX hybrid connect—which delivers optimized data center extension capabilities for seamless and secure connectivity between sites and live and bulk migration of application workloads across data centers and clouds without re-architecting the application; NSX SD-WAN—which delivers high-performance, reliable branch access to cloud services, private data centers, and SaaS-based enterprise applications; and the like.

Although the identified products are VMware products, it is done for purposes of clarity. It should be appreciated that there may be other products from other companies that perform similar tasks and could be easily incorporated/used in place of/or otherwise utilized by CPOD 320 and/or cloud provider hub 325.

With reference now to FIG. 4, a block diagram of the CPOD designer and creator is shown in accordance with an embodiment. In general, CPOD 320 designer and creator provides the design and creates the package to kick off the build as described in FIG. 5. In one embodiment, CPOD 320 designer and creator includes a web interface 410, a microsite 420, a host 430, customization files 440, zip file 450, and email link 460.

In a cloud provider environment, service provider 405 needs to gain the efficiency of standardization and be able to use a standardized software stack that they purchased from VMware (or the like), so they don't have to develop it from scratch. At the same time, they need the flexibility to differentiate that is they don't want to have the same capability of provider A and provider B, etc. Instead, service provider 405 needs to be able to offer a unique identity to a customer and provide tailor-based solutions to a customer which is a challenge from the service provider perspective.

For example, a service provider 405 can run into a problem with a deployment consumption of containers. In general, containers are an application deployment vehicle that developers are utilizing vastly and demanding. Service providers want to be able to easily provide container-based infrastructure to their end-tenant in an efficient way utilizing their existing multi-tenant hardware. So with the infrastructure that is deployed by CPOD they will be able to offer either, or both of, a provider managed capability to spin up containers for multiple tenants so they could have containers a containers be containers see on the same pool of hardware; or they can allow self-service capabilities where the self-service allows the tenant to have their own environment, a UI interface and be able to provision container environments for themselves on their stack. In so doing, the CPOD fits in at the deploying of the infrastructure and the ability to be able to provide this service this capability to the customer(s) of service provider 405.

In one embodiment, the service provider 405 will log into a web interface 410 (e.g., a gated web login, or the like). Once service provider 405 successfully logs in, they will be given access to a microsite 420 which is a pod designer web interface.

In one embodiment, microsite 420 can include a number of different modes such as, but not limited to, a basic mode, an advanced mode, a reconfiguration mode, or the like. If service provider 405 uses the basic mode, they will be provided with very limited customization options which will result in a relatively default design and default automation package.

For example, because compliance requirements, security requirements, operational requirements are at some level, going to be about the same across all customers/tenants. The lowest level of granularity will allow the CPOD to pre-configure a number of operations for customers. The commonality of operations could include, but is not limited to, public-cloud, multi-tenancy, a management portal such as a provider interface, a management portal such as a tenant interface, enforcement of strict isolation of the workloads between tenants, etc.

Additional commonality can include, but is not limited to, turnkey private and multi-tenant cloud services; datacenter extension and hybridity services; operations and monitoring services; cloud management and migration services; security and compliance services; backup, availability and data protection services; and the like. In so doing, CPOD can generate a full-fledged customized, software designed, datacenter, in a significantly reduced amount of time, such as a few hours, or the like.

In addition, if service provider 405 selects the advanced mode, then they will be able to select and/or modify a number of different categories and design inputs. In one embodiment, reconfiguration mode will allow the service provider 405 to import an existing configuration (possibly created by CPOD) in order to make updates and adjustments.

Once service provider 405 has completed the design using microsite 420, the information will be provided to host 430 which will provide the information to the back-end customization 440. In general, customization 440 is a CPOD generator that creates all the customize design files that can include word documents, Excel files, Visio diagrams, architecture diagrams, and the like. In one embodiment, customization 440 combines the files into a PDF file that includes all of the necessary design and configuration documentation. In one embodiment, customization 440 generates an automation package that includes all of the necessary deployment and configuration aspects for the cloud environment.

Thus, aspects include design, build, operate and customized documentation. In the output of the documentation guidance is tied into a standardized VMware side design which is best practice guidance developed overtime and provided to customers. In one embodiment, the output of the documentation provided by the CPOD is a VMware validated design for service provider 405.

In one embodiment, customization 440 can generate a customized configuration around an IP address (e.g., a networking scheme based on the input that has been provided), and uses capabilities such as a config and a VMware vRealize Orchestrator (VRO) and the automation bundle to create a customized automation bundle. In one embodiment, the PDF version of the customized documentation that is aligned with the VMware cloud designer guidance and the customized automation package is then zipped 450 (or otherwise packaged for size and accessibility.

Moreover, customization 440 can validate a design and test for interoperability before the build out. That is, the validation and testing for interoperability would mean, that the build out, the design, the deployment, and corresponding documentation that is provided to the customer will include assurance that there are no interoperability issues between any of the components in the deployed product. The documentation and interoperability assurance will also include extensibility aspects to ensure that any future addition of modules, components, features, or operational changes/enhancements will not result in problems with either interoperability or scale. Moreover, the guidance will identify what aspects of the design are deployable and what aspects of the design would cause problems when a provider attempts to develop a combination, or deploy a combination, that would have interoperability or scale issues.

Thus, embodiments provide a benefit to the service provider 405 in that they don't have to focus on infrastructure they can spend less time building out infrastructure and more time on designing and customize services to the individual entity. This will provide additional value-added capabilities whether it is additional management services, more customization of the service itself, or specific to higher level business values instead of just focusing on the underlying infrastructure.

In one embodiment, the package is then output to service provider 405 via an email with a link 460. When the provider selects the link 460, they will be able to download a PDF version of the customized documentation that is aligned with the VMware cloud designer guidance and the customized automation package that they will then use in the deployment aspect of CPOD discussed below in FIG. 5.

If the provider was trying to do this natively without utilizing the CPOD products, it would require that the provider build their own software. Such a software build would require a significant amount of time, manpower, and resources.

In contrast, using the CPOD process described herein will reduces the costs, time, etc. In other words, CPOD design and creation provides a prepackaged semi-configured solution for various potential need or demands for the cloud implementor. Moreover, the pods are easily modifiable and configurable such that a provider can have a customized solution ready to roll out while incurring the need of only minor modification, as opposed to the service provider 405 coding the customized virtual environment from scratch.

Further, the CPOD designer aspect is based on the input of the provider. So, for example, if the provider wanted a migration capability, then based on the migration capability request, there will be specific documentation and guidance created from a documentation perspective. In addition, the actual automation package of what is to actually be deployed in the VM environment, will be installed by the CPOD deployer. Thus, the service provider 405 will have the actual solution and the underlying documentation for the actual solution.

Referring now to FIG. 5, a flow diagram of a method for deploying the CPOD design on a bare metal environment (such as the environment of FIG. 2) is shown in accordance with an embodiment. In general, flow diagram 500 illustrates an embodiment for a vCenter server automated deployment. Although a number of different steps are shown, it should be appreciated that there may be more of fewer steps within the deployment process. The steps shown in flowchart 500 are merely one method for performing the deployment. In some cases, steps could be combined, removed, added, or the like to adjust, modify or otherwise adjust the deployment process while remaining within the scope of a given deployment. Thus, the steps as shown are provided for clarity and enablement for one of the possible deployment procedures.

In general, the deployment is an automated deployment that occurs in the background. In one embodiment, CPOD OVA uses a CPOD initiator. In one embodiment, the CPOD initiator is an OVA which is a downloadable single-file distribution that contains the ESXI image and also contains all the products that the CPOD deploys such as all of the product binaries, CentOS binaries and packages required for supplement CentOS VMs. In addition, the CPOD OVA also contains the CPOD initiator VM. The service provider 405 will download the package, and install it into a supported hypervisor (or the like) that is in the VM environment. In one embodiment, it can be installed on VMware work station, VMware Fusion, an existing ESXI host, or the like. This nested CPOD initiator VM will then allow the provider to boot up, login to a vRealize Orchestrator interface and be able to kick off the workflow that will start the deployment process.

With reference now to 510 of FIG. 5, one embodiment prepares a management cluster. In one embodiment, the management cluster preparation initially deploys a CPOD OVA on an ESXi, a Workstation, or the like. The configuration is imported from the cloud pod website. The ESXi deployment is kickstarted for the management cluster and the vCenter is then deployed. The vCenter server is configured and the vRO and base images are deployed. The NSX manager is then deployed and configured on the management cluster.

In one embodiment, the CPOD initiator will run the configuration workflow in vRealize Orchestrator, which is one of the products nested within the CPOD initiator. All of the workflows, which in one embodiment, are built in vRealize Orchestrator, will start the initial build on the bare metal of the environment. It will reach out over the network, initiate, through a Pixi-boot, the startup and build in the management of the ESXi host, it will deploy the management components needed to build the public cloud to include the vCenter. It will configure a cluster for software to find storage using vCenter or an IP storage if not using another storage.

In one embodiment, the CPOD OVA will deploy a CentOS template to the cluster that will initiate the copy of the configuration from the initial CPOD initiator VM over to the now deployed management cluster. In addition, it will create a customer install server and copy files from the initial CPOD initiator VM and deploy the management workloads, e.g., management products such as NSX, vCloud director, etc. In one embodiment, the components of the build will be dependent upon what the provider selected during the customization, and will drive what will be built out as part of the management pod.

With reference now to 520 of FIG. 5, one embodiment deploys a vCloud director and companion products. In one embodiment, after the management cluster is prepared, one embodiment deploys and configures NSX ESX (LBS, NAT,FW), then deploys Postgres DB server (centOS) and configures postgres for a vCloud Director. One embodiment then deploys and configures NFS transfer server (centOS). RabbitMQ(centOS) is deployed and Cassandra nodes (centOS) are deployed and configured. vCloud director cell 1 (centOS), and vCloud director cell 2 (centOS) are also deployed. Once deployed, vCloud director on cell 1 and vCloud director on cell 2 are configured. The vCloud director for RabbitMQ is configured and vCloud usage meter is deployed and configured. In one embodiment, VRLI is deployed and vCD, NSX, and VCSA are configured. vR Ops is also deployed and vCD, NSX, and VCSA are further configured. The PSC for the resource pods is deployed. Afterward, vCenter server for resource pod 00 is deployed and configured and then the NSX for Resource Pod 00 is deployed and configured.

In one embodiment, the initial CPOD initiator VM is then destroyed and the configuration now resides only in the management cluster. In the multi-tenant cloud environment, the management cluster that all the products live in that control the management interface, provider interface, tenant interface, there are resource clusters that the tenant will run their workloads in. This operation builds out the management cluster and provides the automation of the building of the resource cluster.

With reference now to 530 of FIG. 5, one embodiment deploys a resource cluster. In one embodiment, the deployment of the resource cluster begins by configuring a kickstart server for the resource cluster RCxx. In addition, one embodiment, performs a kickstart ESXi deployment for the management cluster. Hosts are then added to cluster RCxx, the vSAN is configured. Finally, the NSX controller is deployed and the Hosts are prepared.

Once the CPOD initiator is destroyed, the management cluster will deploy the resource cluster. In one embodiment, a minimum build would be 4 hosts in the management cluster and 4 hosts in the resource cluster. In another embodiment, a build could include up to 64 hosts or more.

Although a number of VMware products are discussed herein, the use of VMware products is provided for purposes of clarity in the discussion, similar products from other manufacturers should be considered as being within the scope of the present technology.

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

The invention claimed is:

1. A computer-implemented method for automated deployment of a cloud environment, said computer-implemented method comprising:
accessing, via a user interface, a cloud provider pod designer;
the cloud provider pod designer comprising a plurality of cloud provider platform components;
receiving instructions comprising a plurality of cloud environment requirements via the user interface;
providing, via the user interface, optimization suggestions for a cloud provider platform based on the cloud environment requirements;
designing, via the cloud provider pod designer, a cloud provider platform; and
deploying the cloud provider platform.

2. The computer-implemented method of claim 1 wherein the plurality of cloud provider platform components is selected from the group consisting of: a vSphere, a NSX, and a vCloud director.

3. The computer-implemented method of claim 1 wherein the plurality of cloud provider platform components includes a number of optional products selected from the group consisting of: a vSAN, a vCloud extender, a vRealize operations, a vRealize log insight, and a vRealize network insight.

4. The computer-implemented method of claim 1 further comprising:
providing a plurality of modes for the cloud provider pod designer, the plurality of modes comprising:
a basic mode,
an advanced mode, and
a reconfiguration mode, wherein the reconfiguration mode is for reconfiguring a design previously generated by said cloud provider pod designer.

5. The computer-implemented method of claim 1 further comprising:
generating a set of customized design files reflective of the cloud provider platform, the set of customized design files comprising a design and a configuration documentation.

6. The computer-implemented method of claim 5 wherein the set of customized design files include a number of files selected from the group consisting of: a text document, a spreadsheet, a CAD drawing, and an architecture diagram.

7. The computer-implemented method of claim 1 further comprising:
customizing the deploying of the cloud provider platform with a configuration based on a tenant's IP address.

8. A computer-implemented method for automated deployment of a multi-tenant cloud environment in a bare metal environment, said computer-implemented method comprising:
receiving an automation package that includes a plurality of deployment and configuration aspects for a pre-designed multi-tenant cloud environment;
automatically preparing a management cluster based on a management requirement in the automation package;
automatically deploying a vCloud director and a plurality of companion products based on a director and companion product requirement in the automation package; and
automatically deploying a resource cluster based on a resource requirement in the automation package.

9. The computer-implemented method of claim 8 further comprising:
downloading the automation package; and
installing the automation package into a supported hypervisor that is in a VM environment within the multi-tenant cloud environment.

10. The computer-implemented method of claim 8 further comprising:
configuring a cluster for software to find storage using a vCenter or an IP storage.

11. The computer-implemented method of claim 8 further comprising:
deploying a CentOS template to the management cluster that will initiate a copy of the plurality of deployment and configuration aspects for the pre-designed multi-tenant cloud environment to the management cluster.

12. The computer-implemented method of claim 11 further comprising:
destroying the received plurality of deployment and configuration aspects for the pre-designed multi-tenant cloud environment such that only the copy of the deployment and configuration aspects for the pre-designed multi-tenant cloud environment remains in the management cluster.

13. The computer-implemented method of claim 12 further comprising:
automatically deploying the resource cluster only after the received plurality of deployment and configuration aspects for the pre-designed multi-tenant cloud environment are destroyed.

14. The computer-implemented method of claim 8 further comprising:
receiving a set of customized design files reflective of the pre-designed multi-tenant cloud environment, the set of customized design files comprising a design and a configuration documentation.

15. A computer implemented system for development and automated deployment of a multi-tenant cloud bare metal environment, said system comprising:
a service provider to receive a plurality of requirements for a tenant cloud environment,
the service provider to develop a public cloud environment for a tenant based on the plurality of requirements;
a cloud provider platform to design the public cloud environment for the service provider based on an input received from the service provider; and
a multi-tenant cloud bare metal environment to receive and automatically install the design of the public cloud environment from the cloud provider platform.

16. The computer implemented system of claim 15 wherein the service provider is further to:
input the plurality of requirements for the tenant cloud environment into the cloud provider platform.

17. The computer implemented system of claim 15 wherein the service provider is further to:
select one or more of a plurality of programs to customize the tenant cloud environment; and
input one or more of the plurality of programs into the cloud provider platform.

18. The computer implemented system of claim 15 wherein the service provider is further to:
select one or more of a plurality of management offerings to customize the tenant cloud environment; and
input one or more of the plurality of management offerings into the cloud provider platform.

19. The computer implemented system of claim 15 wherein the service provider is further to:
utilize a web interface to input any information into the cloud provider platform; and
receive an email with a link from the cloud provider platform,
the link comprising the design of the public cloud environment from the cloud provider platform,
a selection of the link to cause the automatic installation of the design of the public cloud environment from the cloud provider platform in the multi-tenant cloud bare metal environment.

20. The computer-implemented system of claim 15 wherein the cloud provider platform is further to:
generate a set of customized design files reflective of the design of the public cloud environment, the set of customized design files comprising a design and a configuration documentation.
